(19) United States
(12) Patent Application Publication
(10) Pub. No.: US 2013/0297698 A1
(43) Pub. Date: Nov. 7, 2013

(54) Method and Apparatus for Utilizing Context and Profile Information in Content Searching and Recommendation

(71) Applicants: Billy Odero, Nairobi (KE); Pauline Githinji, Karen (KE); Brian Gichana Omwenga, Nairobi (KE)

(72) Inventors: Billy Odero, Nairobi (KE); Pauline Githinji, Karen (KE); Brian Gichana Omwenga, Nairobi (KE)

(73) Assignee: NOKIA CORPORATION, Espoo (FI)

(21) Appl. No.: 13/886,166

(22) Filed: May 2, 2013

(30) Foreign Application Priority Data
May 7, 2012 (KE) KE/P/2012/001567

(51) Int. Cl. H04L 29/08

(52) U.S. Cl. CPC H04L 67/306
USPC 709/204

(57) ABSTRACT

An approach is provided for utilizing context and profile information in content searching and recommending while in an offline mode. A searching/recommending module on a first device determines a content item, an information item, or a combination thereof available on another device. The searching/recommending module on the first device or the other device determines a profile associated with the other device. The searching/recommending module on the first device or the other device makes a comparison of the profile associated with the other device with a profile associated with the first device. The first device causes a request for a content item, an information item, or a combination thereof available on the other device based, at least in part, on the comparison.

### BACKGROUND

Service providers and device manufacturers (e.g., wireless, cellular, etc.) are continually challenged to deliver value and convenience to consumers by, for example, providing compelling network services. One area of interest has been the development of services and applications that enable users to search for, recommend, obtain, share, and distribute content (e.g., songs, movies, pictures, electronic books, etc.) according to context and user profile. However, in developing markets (e.g., China, India, and Africa) Internet access is still challenging and costly. More specifically, many users in these regions may have to rely on content vendors, invest in a computer or an Internet capable device, and utilize slow Internet and/or communication networks in order to search for, recommend, obtain, share, and distribute content via the Internet. As a result, a majority of users in developing countries have limited access to content that is distributed over the Internet and/or social networking services (e.g., FACEBOOK, TWITTER, etc.). Accordingly, service providers and device manufacturers face significant technical challenges to provide users in emerging markets with the ability to search, obtain, share, and distribute content according to context and user profile without a need to access a communication network.

### SOME EXAMPLE EMBODIMENTS

Therefore, there is a need for an approach for utilizing context and profile information in content searching and recommendation while in an offline mode.

According to one embodiment, a method comprises determining, by a first device, one or more content items, one or more information items, or a combination thereof available on at least one other device. The method also comprises determining one or more profiles associated with the at least one other device. The method further comprises causing, at least in part, a comparison of the one or more profiles associated with the at least one other device with one or more profiles associated with the first device. The method additionally comprises causing, at least in part, at least one request for one or more content items, one or more information items, or a combination thereof available on the at least one other device based, at least in part, on the comparison.

According to one embodiment, an apparatus comprising at least one processor; and at least one memory including computer program code for one or more programs, the at least one memory and the computer program code configured to, with the at least one processor, cause the apparatus to determine, by a first device, one or more content items, one or more information items, or a combination thereof available on at least one other device. The apparatus is further caused to determine one or more profiles associated with the at least one other device. The apparatus is also caused to cause, at least in part, a comparison of the one or more profiles associated with the at least one other device with one or more profiles associated with the first device. The apparatus is additionally caused to cause, at least in part, at least one request for one or more content items, one or more information items, or a combination thereof available on the at least one other device based, at least in part, on the comparison.

According to another embodiment, a computer-readable storage medium carrying one or more sequences of one or more instructions which, when executed by one or more processors, cause, at least in part, an apparatus to determine, by a first device, one or more content items, one or more information items, or a combination thereof available on at least one other device. The apparatus is further caused to determine one or more profiles associated with the at least one other device. The apparatus is also caused to cause, at least in part, a comparison of the one or more profiles associated with the at least one other device with one or more profiles associated with the first device. The apparatus is additionally caused to cause, at least in part, at least one request for one or more content items, one or more information items, or a combination thereof available on the at least one other device based, at least in part, on the comparison.

According to another embodiment, an apparatus comprises means for determining, by a first device, one or more content items, one or more information items, or a combination thereof available on at least one other device. The apparatus also comprises means for determining one or more profiles associated with the at least one other device. The apparatus further comprises means for causing, at least in part, a comparison of the one or more profiles associated with the at least one other device with one or more profiles associated with the first device. The apparatus additionally comprises means for causing, at least in part, at least one request for one or more content items, one or more information items, or a combination thereof available on the at least one other device based, at least in part, on the comparison.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-20 and 36-38.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of utilizing context and profile information in content searching and recommendation while in an offline mode, according to one embodiment;

FIG. 2 is a diagram of the components of a content searching and recommending module, according to one embodiment;

FIGS. 3 and 4 are flowcharts of processes for searching and recommending content among multiple devices while in an offline mode, according to various embodiments;

FIG. 5 is a diagram of an example system including multiple users, according to various embodiments;

FIG. 6A-6D are example user interface diagrams utilized in searching and recommending content among multiple devices, according to various embodiments;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for utilizing context and profile information in content searching and recommendation while in an offline mode are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

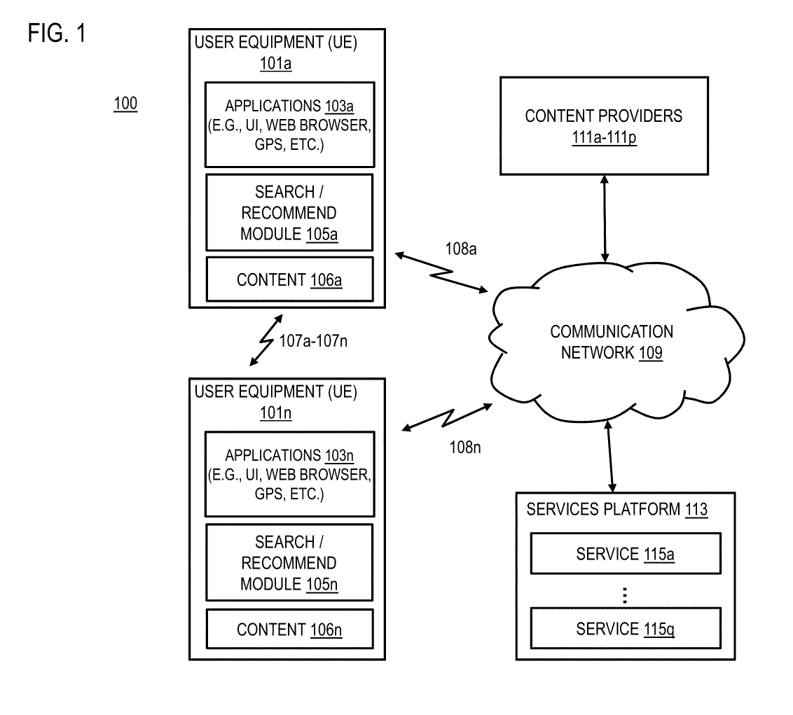

FIG. 1 is a diagram of a system 100 providing capabilities for utilizing context and profile information in content searching and recommendation while in an offline mode, according to one embodiment. As previously discussed, in developing markets (e.g., China, India, and Africa) obtaining Internet access is still a challenge for a majority of users. As a result, the majority of users in these regions have limited access to online capabilities for searching, obtaining, sharing, and distributing content (e.g., songs, movies, pictures, electronic books, etc.) over the Internet and/or social networking services (e.g., FACEBOOK®, TWITTER®, etc.) Traditionally, users need to connect to the Internet (e.g., via a communication network link) in order to search and obtain content from one or more online service providers (e.g., a search engine, a content provider, etc.) or from another online user willing to share, sell and/or distribute a content item with other users. Further, many online service providers collect user information to, at least, create user profiles for determining various characteristics about a user, for example, user interest, likes, dislikes and preferences associated with various contents and services offered by various content and service providers. Furthermore, as users search for and utilize/consume various services and/or contents, the online service providers track and log utilization and consumption histories associated with a user and use the log information to recommend and/or provide various services and/or contents that are better suited to the user's preferences. Moreover, the online service providers also utilize users' profile information, which are associated with various online services (e.g., FACEBOOK®, TWITTER®, etc.) However, when users are offline, it can be challenging for them to search for and obtain (e.g., buy, sell, share, etc.) contents from other devices in close proximity since the current systems and applications (e.g., for searching, selling, buying, content sharing, etc.) lack the utilization of users' profile and preference information (e.g., likes, dislikes, location, content relevancy, etc.) required to provide appropriate, focused, and relevant services (e.g., recommendation) and/or contents to the users. Additionally, current online services such as search and recommendation services focus on users' historical utilization data analysis, profile information tracked and logged by the service providers and/or provided by the users, may not be necessarily useful in search and recommendation tasks that require current and active service and/or content consumption information at a given time and location in order to render useful, accurate contents and services.

To address these problems, a system 100 of FIG. 1 introduces the capabilities for utilizing context and profile information in content searching and recommendation while in an offline mode among multiple devices without a need for the devices to have an active connection to the Internet or a communication network (e.g., while in an offline mode.) More specifically, one or more algorithms and/or applications on a device may intelligently profile content and information from at least one other device (e.g., neighboring device in close proximity, via Bluetooth®, etc.), utilize one or more user profiles associated with the device and the at least one other device, and present one or more catalogs and/or recommendations of content and/or services to the user of the device. In other words, the system 100 enables a first device to browse for content on one or more other devices nearby (e.g., via Bluetooth®, NFC (near filed communication), etc.) and present the content based on one or more profiles, preferences, locations, context, activities, and the like associated with the user, the first device, users of the one or more other devices and/or the one or more other devices.

In one embodiment, the system 100 enables the first device to browse for one or more other devices nearby, establish one or more communication channels (e.g., via Bluetooth®, NFC (near filed communication), etc.) with the one or more other devices, search for one or more catalogs available on the one or more other devices and present the one or more catalogs (e.g., including one or more content and/or information items) to the user at the device. In another embodiment, the first device may generate one or more new catalogs based on the one or more catalogs on the one or more other devices based on one or more profiles and preferences, which may be determined by the user and/or by analysis of historical content/information/service consumption data associated with the user and/or with the device. Additionally, each catalog and/or content item can have a unique identifier to indicate source, type, price, rating, ranking, frequency of use, and the like. Further, one or more content and/or information items can be selected from the one or more catalogs and/or from the one or more new catalogs, presented and/or recommended to the user based on the one or more profiles and preferences whereby the user may choose to view, review, buy, share, rent, and the like, the one or more content items.

Moreover, the system 100 may recommend contents and services to a user by determining what contents and/or services are currently being consumed by other users in close proximity to the user; for example, a service provider may recommend a song that other users located near the user are listening to, or a news article that the other users are reading. Furthermore, combining social and contextual elements to search and recommendation schemes would present the possibility of generating one or more recommendations for the user based on what consumption habits the other users have, which can provide a more complete social experience for the user.

In another embodiment, the system 100 enables a first device to browse content preferences and consumption patterns on the one or more other devices (e.g., a group of other devices) and aggregate the groups' preferences and consumption pattern to render one or more recommendation lists to one or more users. Further, if a new device joins the group or within communication range of the device, then the recommendation lists are recalculated taking into account catalogs, contents, information, and the like available on the new device. Similarly, if a device moves out of the group (e.g., leaves, loses/breaks communication, turns off, etc.), then the recommendation lists are recalculated taking into account catalogs, contents, information, and the like, that were available on the device leaving the group.

In one use example, a user with a first device enters a room, where other devices are also present nearby. Further, the first device with capabilities of the system 100 determines a list of songs on the other devices as well as preferences those songs have among the other users/devices. Further, the first device can aggregate a list of “hot” songs favored by the users in the room, while the aggregating algorithm/application may or may not consider the first device user's own music preferences. In this example, the list of “hot” songs may also result in a dynamic “top 10” list of popular songs at a given time and among a given group of devices/users/people.

In another example, a user with a first device enters a shopping store wherein the first device determines, from other devices in the store, information associated with one or more other users' (e.g., via one or more other devices) shopping habits, products of interest, available coupons, and the like.

In various embodiments, the system 100 provides capabilities for one or more devices to determine content available on one or more other devices, catalog and present the content on the one or more devices and based on context, user preferences, profiles, device type, or a combination thereof wherein one or more users may choose to share, sell, buy, distribute, rent, review, or a combination thereof, the content. In one embodiment, the first device may request to download one or more available content items from the one or more other devices in exchange (e.g., purchase) for transfer of one or more credit points to the one or more other devices wherein the credit points may be online points, monetary points (e.g., available in an account), gaming points, and the like. Further, the first device may substantially simultaneously request and transmit (e.g., buy and sell, download and upload) one or more content items from and to the one or more other devices utilizing one or more communication methods, for example, Bluetooth®, NFC, IrDA™, WLAN, and the like.

In one embodiment, in the system 100 a first device determines one or more content items, one or more information items, or a combination thereof available on at least one other device. For example, the first device monitors, searches for and discovers at least one other device nearby over one or more proximity communication methods (e.g., Bluetooth®, NFC) and requests for one or more catalogs of one or more content items (e.g., songs, movies, pictures, electronic books, mobile applications, news articles, coupons, etc.) available on the at least one other device. Further, the one or more information items include a recommendation, a ranking, a rating, one or more comments, or a combination thereof. Additionally, the first device and the at least one other device communicate via one or more proximity communication methods (e.g., Bluetooth®, NFC, WLAN, etc.) to send and receive communication messages among multiple devices (e.g., the first device, the at least one other device, etc.)

In one embodiment, the system 100 determines one or more profiles associated with the at least one other device. In one example, there are one or more user and/or device profiles associated with the at least one other device wherein the profiles include user and/or device information such as age, gender, social interests, social networks, education, profession, favorite music genre, favorite movie, device type, and the like. Further, the profile information of a user and/or a device may be made available by a user of a device to a limited number of other users and/or other devices.

In one embodiment, the system 100 causes a comparison of the one or more profiles associated with the at least one other device with one or more profiles associated with a first device. In one example, at least one profile information a user currently utilizing the first device is compared with profile information of at least one user currently utilizing the at least one other device. In another example, only a subset of the user profile of the first device and of the at least one other device (e.g., age and gender) are compared. In various embodiments, the one or more profiles associated with the first device and/or with the at least one other device may be processed and/or analyzed by the first device and/or by the at least one other device. For example, the first device may entirely or partially process one or more profiles associated with the first device and/or one or more profiles associated with the at least one other device. In another example, the at least one other device may entirely or partially process one or more profiles associated with the at least one other device and/or one or more profiles associated with the first device.

In one embodiment, the system 100 causes at least one request for one or more content items, one or more information items, or a combination thereof available on the at least one other device based, at least in part, on the comparison. For example, the first device transmits one or more requests to the at least one other device for one or more content items based on the profile comparison results indicating that one or more profile information items (e.g., age, gender) were similar or matched according to one or more profile comparison parameters set by the user of the first device.

In one embodiment, the system 100 causes a comparison of the one or more content items, the one or more information items, or a combination thereof available on the at least one other device with one or more content items, one or more information items, or a combination thereof available on the first device. In one example, the first device receives one or more catalogs/lists of one or more content items (e.g., songs, movies, etc.) available on the at least one other device and compares them to one or more catalogs/lists and/or to one or more content items available on the first device, wherein the one or more content items on the at least one other device and the first device are associated with one or more same identification information per content item.

In one embodiment, the system 100 processes and/or facilitates a processing of social networking information, one or more social graphs, or a combination thereof associated with the one or more user profiles of the first device and/or with the at least one other device. For example, user profiles and/or profile information may include social networking information, one or more social graphs, or a combination thereof which can be utilized to determine if a user is associated with a certain social networking group; or participates in trading, sharing, selling, buying, etc., of content items from other users; or belongs to a certain information gathering and sharing collective wherein one or more other users are identified and associated with the user, or a combination thereof.

In one embodiment, the system 100 causes an aggregation of the one or more content items, the one or more information items or a combination thereof available on the first device and the at least one other device. For example, the first device compares and aggregates the one or more catalogs and/or the one or more content items available on the at least one other device with one or more catalogs and/or one or more content items available on the first device and/or available on one or more other devices wherein the aggregated content and/or information may contain comments, rankings, ratings, recommendations, and the like from users of the one or more other devices.

In one embodiment, the one or more content items include one or more media items, one or more applications, or a combination thereof and wherein the one or more information items include one or more commenting information, one or more search results, one or more content consumption histories, one or more recommendations, or a combination thereof. For example, the one or more media items include songs, movies, pictures, electronic books, news articles, etc. and the one or more applications include mobile applications, gaming applications, and the like. Further, the one or more commenting information includes comments (e.g., like, dislike, experience, details, etc.) by one or more other users, content providers, service providers and the like. Furthermore, the one or more consumption histories include consumption information, for example, date, location, frequency of consumption, tools, etc. Additionally, the recommendations include information on ratings, rankings, and the like.

In one embodiment, while a device is offline (e.g., not utilizing a cellular connection), one or more other methods may be utilized to determine device location. For example, a user may indicate/enter a current location via one or more applications on the device. In another example, a local connection (e.g., WLAN) may be utilized to determine the current location of the device. In another example, a first device may utilize location information of at least another device to determine location of the first device.

In one embodiment, the system 100 determines one or more privacy policies, one or more security policies, or a combination thereof associated with the one or more content items, the one or more information items, the first device, a user of the first device, the at least one other device, a user of the at least one other device, or a combination thereof. In various embodiments, a user and/or a content provider may associate one or more privacy and/or security policies with one or more content items, one or more portions of the one or more content items, a user, a device, one or more other users, and the like. In one embodiment, a user may register the privacy/security policies in a device for future reference when accessing sharing/selling the one or more content items.

In one embodiment, the system 100 causes a presentation of the one or more content items, the one or more information items, or a combination thereof at the first device based, at least in part, on the one or more privacy policies, the one or more security policies, or a combination thereof. For example, under the one or more privacy policies, presentation, use, and/or sharing of the content items, the recommendation, the rankings, the ratings, and/or the commenting information may be limited to a certain user or group of users. For example, only members of a certain group of users (e.g. a club, a social networking group, etc.) may access and/or utilize catalogs and/or contents available on devices belonging to that certain group of users. In one example, a user may choose to only share/sell most recently released songs by a certain artist available in the device catalog.

In one embodiment, the system 100 causes one or more updates on availability of the one or more contents, the one or more information items or a combination thereof based, at least in part, on at least one new device joining or the at least one other device leaving a group of devices in communication with the first device. For example, a group of devices are in close proximity to each other (e.g., in a room) and have established communication channels within the group among the devices and have exchanged information associated with each device such as user profiles, device profiles, content catalogs, content items, recommendation lists and the like. In one use case scenario, a new device (e.g., a new user) joins the group, which causes the devices (e.g., at least one) already in the group to update current information on each device to reflect any changes due to new information (e.g., user profiles, device profiles, content catalogs, content items, recommendation lists and the like) associated with the new device. In another use case scenario, one of the devices already participating in the group leaves the group (e.g., leaves the room, breaks communication, etc.) and this causes the other devices in the group to update current information on each device to reflect any changes due to loss of information associated with the device leaving the group.

In another embodiment, the system 100 causes one or more devices to transmit one or more catalogs of one or more content items available the one or more devices via one or more proximity communication channels (e.g., Bluetooth) before receiving a request from one or more other devices (e.g., broadcast) so that the one or more other devices could receive the one or more catalogs without having to transmit a request.

As discussed above, utilization of the system 100 provides intelligent and efficient methods for, at least, searching, discovering, requesting, sharing, selling, buying, exchanging, recommending content among multiple devices while offline. Further, the methods enable user and devices to request and receive content based on user profiles and user interests while minimizing efforts in filtering and sorting through unwanted (e.g., spam) content from other devices. Additionally, the system 100 enable users and devices to determine what content (e.g., music, movies, news, coupons, etc.) other nearby users and devices are interested in, are searching for, are consuming, are recommending, are selling, are exchanging, are buying, are sharing, and the like.

As shown in FIG. 1, the system 100 comprises one or more user (UE) 101a-101n (e.g., a mobile phone) (also collectively referred to as UEs 101) which may be utilized to execute applications 103a-103n (e.g., a social networking application, a web browser, a media application, user interface, GPS, a mapping application, a web client, etc.) to access one or more available online services at a services 115a-115q (also collectively referred to as services 115) and/or one or more content providers 111a-111p (also collectively referred to as content providers 111) via communication channels/links 108a-108n (e.g., cellular network links) over a communication network 109. The services 115 may comprise one or more services, for example, financial services, social networking services, online shopping, media upload, media download, media streaming, account management services, or a combination thereof. The content providers 111 may provide to the UEs 101 and/or to the services platform 113 a range of content items such as songs, movies, pictures, electronic books, mobile applications, and the like. In one embodiment, the UEs 101 may also communicate with each other via one or more proximity (e.g., Bluetooth®, NFC, WLAN, IrDA™, etc.) wireless communication links 107a-107n (also collectively referred to as wireless communication links 107) and utilize search/recommend modules 105a-105n (also collectively referred to as search/recommend (S/R) module 105) to search and recommend one or more content 106a-106n (including one or more content items and also collectively referred to as content 106) from one or more UEs 101 to one or more other UEs 101.

In one embodiment, the S/R module 105 on a UE 101 is capable of substantially simultaneously transmitting and receiving one or more content items to and from one or more other UEs 101. For example, a first device can receive one or more content items from one or more other devices and at the same time, transmit one or more content items to one or more other devices over one or more communication links (e.g., Bluetooth®, NFC, WLAN, etc.)

In one embodiment, the S/R module 105 causes a rendering of at least one user interface (e.g., a GUI) at the UEs 101 to enable the searching and/or recommending of one or more content 106 (e.g., songs, movies, pictures, electronic books, mobile applications, etc.) among the UEs 101 (e.g., mobile phones) having connectivity via one or more proximity wireless communication links 107. In one embodiment, the content 106 are made available by the content providers 111 (e.g., a mobile application store), the services platform 113 (e.g., one or more social networking services), or a combination thereof and can be stored locally at the UEs 101 for later distribution to other UEs 101. In one example use case, a UE 101 monitors a proximity wireless communication link 107 (e.g., Bluetooth®) for other UEs 101; discovers at least one other UE 101; makes a wireless connection to the other UE 101 via the wireless communication link 107 (e.g., Bluetooth®, NFC); requests a catalog of the content 106 available on the other UE 101 for sharing/selling; selects one or more content items from the catalog; negotiates an exchange of credits/points with the other UE 101, and downloads the one or more content items, via the wireless communication link 107, from the other UE 101 as agreed in the negotiation with the other UE 101.

In one embodiment, each content item in content 106 is associated with a unique identification, which may be assigned by a user, content providers 111, and/or the services platform 113.

In various embodiments, the content items in content 106 may be associated with one or more security parameters including rights management information items, digital rights management (DRM) information items, one or more private and/or public encryption/decryption keys, one or more activation keys, and the like.

By way of example, the communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101, the content providers 111, and the services platform 113 communicate with each other and other components of the communication network 109 using well known, new or still developing protocols. In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

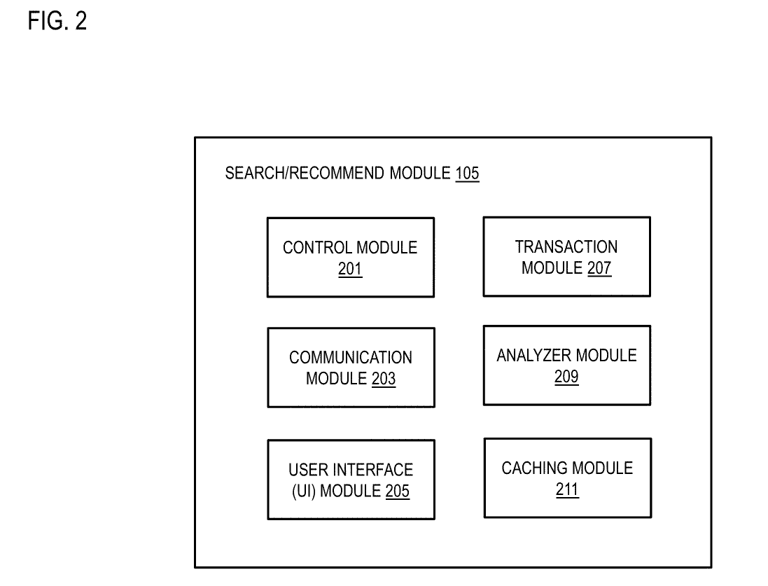

FIG. 2 is a diagram of the components of the search and recommend (S/R) module 105, according to one embodiment. By way of example, the S/R module 105 includes one or more components for searching and recommending content from multiple devices while the devices are in an offline mode. It is contemplated that the functions of these components may be combined in one or more components or performed by other components of equivalent functionality. In one embodiment, the S/R module 105 includes a control module 201, a communication module 203, a user interface (UI) module 205, a transaction module 207, an analyzer module 209, and a caching module 211.

In one embodiment, the control module 201 executes at least one algorithm for executing functions of the S/R module 105. For example, the control module 201 may execute an algorithm for processing one or more interactions among multiple UEs 101 in order to search for and/or recommend one or more content items (e.g., songs, movies, pictures, electronic books, mobile applications, homework assignments, etc.) among the multiple UEs 101 (e.g., mobile phones) via one or more proximity wireless communication links 107 (e.g., Bluetooth®, NFC, WLAN, etc.). By way of another example, the control module 201 may execute an algorithm to interact with the communication module 203 to communicate among the one or more UEs 101, the S/R module 105, the content providers 111, and the services platform 113. The control module 201 also may execute an algorithm to interact with the user interface (UI) module 205 to render at least one user interface (e.g., a GUI) at a UE 101 for searching for and/or recommending one or more content items from the one or more UEs 101 with connectivity to each other. The control module 201 may also execute an algorithm to interact with the transaction module 207 to cause recording/logging of one or more transactions between the one or more UEs 101, the content providers 111, and the services platform 113. Further, the transaction module 207 may also cause reporting of one or more transactional information items (e.g., content items, date, location, distributing device, requesting device, content price, download/upload status, etc.) to the content providers 111, services platform 113 and/or to one or more network components (e.g., a local hub/server). The control module 201 may also execute an algorithm to interact with the analyzer module 209 to determine one or more interactions with one or more UEs 101, to cause a an analysis of one or more requests received from at least one other receive and/or a distribution of one or more content 106 to the at least one other device. Further, the control module 201 may also execute an algorithm to interact with the caching module 211 to cause a caching of the one or more content 106, one or more content items from the content providers 111 and/or from the services platform 113, one or more transactional information items, or a combination thereof. Furthermore, the control module 201 may execute one or more algorithms to encrypt, decrypt, encode, decode, and/or to determine and transmit one or more rights management information and/or digital right management associated with the one or more content items transmitted to and/or received from one or more UEs 101.

The communication module 203 is used for communication between the UEs 101, the S/R module 105, the content providers 111, and the services platform 113. Further, the communication module 203 also may be used to communicate commands, requests, data, transactional information, etc. Furthermore, the communication module 203 may also be used to cause a transfer of one or more content 106 to the at least one other device and/or to one of the one or more UEs 101. More specifically, the communication module 203 may be used in connection with the one or more wireless communication channels (e.g., Bluetooth®, NFC, WLAN, etc.), or a combination thereof. In one embodiment, the S/R module 105 may utilize the communication module 203, in connection with the content 106 and/or the caching module 211, to cause a distribution/sharing of the one or more content 106 from one or more UEs 101 to one or more other UEs 101.

The user interface (UI) module 205 is used to cause a rendering of at least one user interface (e.g., a GUI) at one or more UEs 101 for searching and recommending one or more content 106 (e.g., songs, movies, pictures, electronic books, mobile applications, etc.) among the and one or more UEs 101 with connectivity to at the at least one other device. The user interface module 205, in connection with the analyzer module 209, may also be used to render status information associated with one or more content rights management settings, the one or more UEs 101, one or more catalogs, one or more requests, a transactional information associated with one or more UEs and/or one or more content items, or a combination thereof. Further, the user interface module 205, in connection with the analyzer module 209, may also be used to process the one or more interactions to determine a selection of one or more content 106, one or more credit and/or debit points associated with a transaction, or a combination thereof. The user interface module 205 also may be used to render one or more information items associated with one or more content 106 (e.g., price, artist, publisher, owner, size of file, rating, comments, ranking, etc.), one or more previews (e.g., a one minute sample), or a combination thereof.

The analyzer module 209 may also analyze and determine one or more communication channels available for delivering and/or receiving the one or more content 106 to and/or form one or more UEs 101. For example, one communication channel (e.g., Bluetooth) may be utilized to discover the at least one other and/or the first device and another communication channel (e.g., WLAN) may be utilized to transmit and/or receive the one or more content 106. Further, the analyzer module 209 may also analyze/manage the content items of content 106, for example, create and maintain a current catalog/inventory; associate one or more RMI/DRM rules, one or more ratings, one or more rankings, one or more comments, and the like, with the content items; cause a request for additional content items search and recommendation, determining applicable restrictions (e.g., age restricted) associated with the content items, user profile (e.g., age, gender, profession, education, etc.), device profile (e.g., device type, device capability, etc.) and the like.

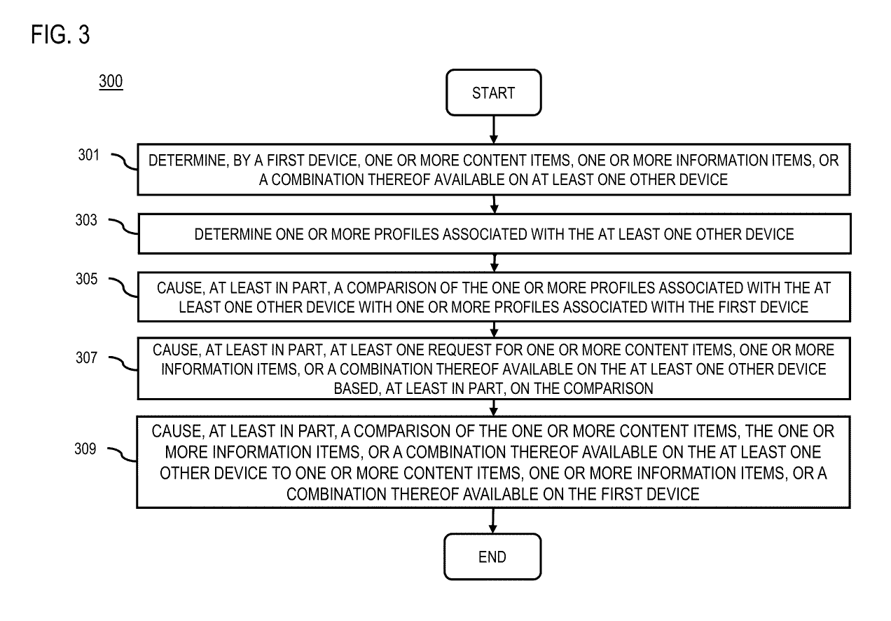

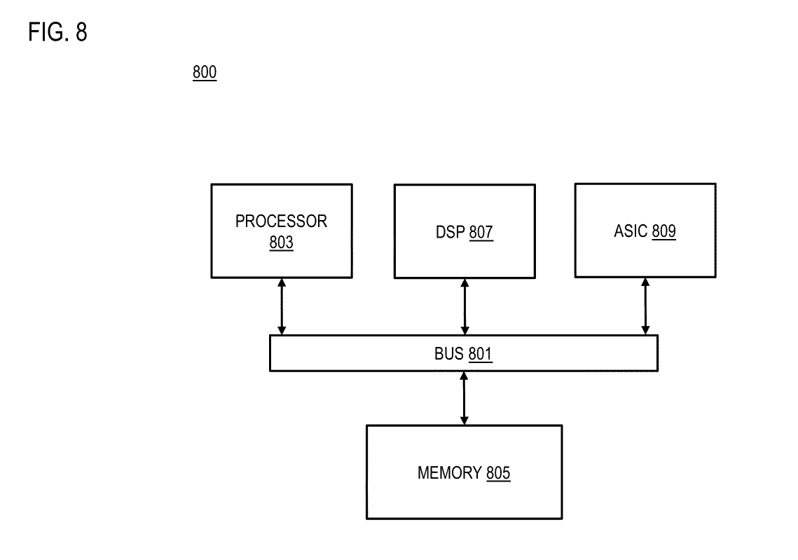

FIG. 3 is a flowchart of a process 300 for searching and recommending content among multiple devices (e.g., mobile phones) utilizing context and profile information in content searching and recommendation while in an offline mode, according to one embodiment. In various embodiments, the control module 201, the search/recommend (S/R) module 105 and/or the services platform 113 perform all or parts of the process 300 and are implemented in, for instance, a chip set including a processor and a memory as shown FIG. 8. In certain embodiments, the UEs 101 utilize one or more S/R modules 105 for searching and recommending one or more content items among multiple devices. Moreover, the applications 103 may execute upon the control module 201.

In step 301, the S/R module 105 at a first device determines one or more content items, one or more information items, or a combination thereof available on at least one other device. For example, the first device monitors, searches for and discovers at least one other device nearby over one or more proximity communication methods (e.g., Bluetooth®, NFC) and requests for one or more catalogs of one or more content items (e.g., songs, movies, pictures, electronic books, mobile applications, news articles, coupons, etc.) available on the at least one other device. Further, the one or more information items include a recommendation, a ranking, a rating, one or more comments, or a combination thereof. Additionally, the first device and the at least one other device communicate via one or more proximity communication methods (e.g., Bluetooth®, NFC, WLAN, etc.) to send and receive communication messages among multiple devices (e.g., the first device, the at least one other device, etc.).

In step 303, the S/R module 105 at a first device and/or at the at least one other device determines one or more profiles associated with the at least one other device. In one example, there are one or more user and/or device profiles associated with the at least one other device wherein the profiles include user and/or device information such as age, gender, social interests, social networks, education, profession, favorite music genre, favorite movie, device type, and the like. Further, the profile information of a user and/or a device may be made available by a user of a device to a limited number of other users and/or other devices.

In step 305, the S/R module 105 at a first device and/or at the at least one other device causes a comparison of the one or more profiles associated with the at least one other device with one or more profiles associated with a first device. In one example, at least one profile information a user currently utilizing the first device is compared with profile information of at least one user currently utilizing the at least one other device. In another example, only a subset of the user profile of the first device and of the at least one other device (e.g., age and gender) are compared. In various embodiments, the one or more profiles associated with the first device and/or with the at least one other device may be processed and/or analyzed by the first device and/or by the at least one other device. For example, the first device may entirely or partially process one or more profiles associated with the first device and/or one or more profiles associated with the at least one other device. In another example, the at least one other device may entirely or partially process one or more profiles associated with the at least one other device first and/or one or more profiles associated with the first device.

In step 307, the S/R module 105 at a first device causes at least one request for one or more content items, one or more information items, or a combination thereof available on the at least one other device based, at least in part, on the comparison. For example, the first device transmits one or more requests to the at least one other device for one or more content items based on the profile comparison results indicating that one or more profile information items (e.g., age, gender) were similar or matched according to one or more profile comparison parameters set by the user of the first device.

In step 309, the S/R module 105 at a first device and/or at the at least one other device causes a comparison of the one or more content items, the one or more information items, or a combination thereof available on the at least one other device with one or more content items, one or more information items, or a combination thereof available on the first device. In one example, the first device receives one or more catalogs/lists of one or more content items (e.g., songs, movies, etc.) available on the at least one other device and compares them to one or more catalogs/lists and/or to one or more content items available on the first device, wherein the one or more content items on the at least one other device and the first device are associated with one or more same identification information per content item.

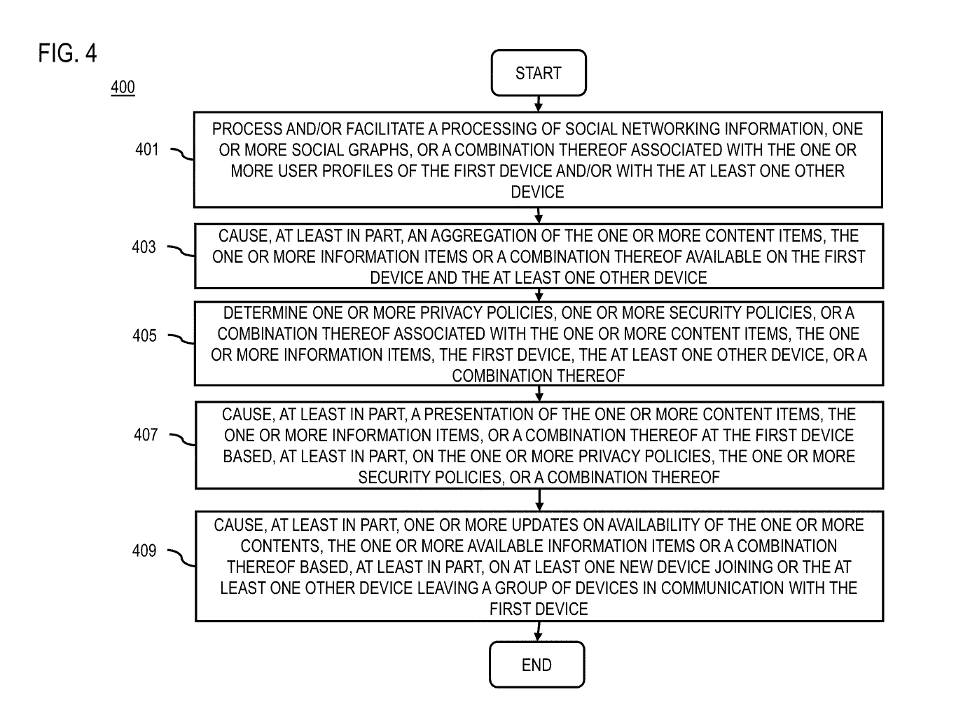

FIG. 4 is a flowchart of a process 400 for processing profile and user information associated with one or more devices and/or content items, according to one embodiment. In various embodiments, the control module 201, the search/recommend (S/R) module 105, and/or the services platform 113 perform all or parts of the process 400 and are implemented in, for instance, a chip set including a processor and a memory as shown FIG. 8. In certain embodiments, the UEs 101 utilize one or more S/R modules 105 for analyzing, searching, and recommending one or more content items among multiple devices. Moreover, the applications 103 may execute upon the control module 201.

In step 401, the S/R module 105 on the first device and/or on the at least one other device processes and/or facilitates a processing of social networking information, one or more social graphs, or a combination thereof associated with the one or more user profiles of the first device and/or with the at least one other device. For example, user profiles and/or profile information may include social networking information, one or more social graphs, or a combination thereof which can be utilized to determine if a user is associated with a certain social networking group; or participates in trading, sharing, selling, buying, etc., of content items from other users; or belongs to a certain information gathering and sharing collective wherein one or more other users are identified and associated with the user, or a combination thereof.

In step 403, the S/R module 105 on the first device and/or on the at least one other device causes an aggregation of the one or more content items, the one or more information items or a combination thereof available on the first device and the at least one other device. For example, the first device compares and aggregates the one or more catalogs and/or the one or more content items available on the at least one other device with one or more catalogs and/or one or more content items available on the first device and/or available on one or more other devices wherein the aggregated content and/or information may contain comments, rankings, ratings, recommendations, and the like from users of the one or more other devices. In one embodiment, the one or more content items include one or more media items, one or more applications, or a combination thereof and wherein the one or more information items include one or more commenting information, one or more search results, one or more content consumption histories, one or more recommendations, or a combination thereof. For example, the one or more media items include songs, movies, pictures, electronic books, news articles, etc. and the one or more applications include mobile applications, gaming applications, and the like. Further, the one or more commenting information includes comments (e.g., like, dislike, experience, details, etc.) by one or more other users, content providers, service providers and the like. Furthermore, the one or more consumption histories include consumption information, for example, date, location, frequency of consumption, tools, etc. Additionally, the recommendations include information on ratings, rankings, and the like.

In step 405, the S/R module 105 on the first device and/or on the at least one other device determines one or more privacy policies, one or more security policies, or a combination thereof associated with the one or more content items, the one or more information items, the first device, a user of the first device, the at least one other device, a user of the at least one other device, or a combination thereof. In various embodiments, a user and/or a content provider may associate one or more privacy and/or security policies with one or more content items, one or more portions of the one or more content items, a user, a device, one or more other users, and the like. In one embodiment, a user may register the privacy/security policies in a device for future reference when accessing sharing/selling the one or more content items.

In step 407, the S/R module 105 on the first device and/or on the at least one other device causes a presentation of the one or more content items, the one or more information items, or a combination thereof at the first device based, at least in part, on the one or more privacy policies, the one or more security policies, or a combination thereof. For example, under the one or more privacy policies, presentation, use, and/or sharing of the content items, the recommendation, the rankings, the ratings, and/or the commenting information may be limited to a certain user or group of users. For example, only members of a certain group of users (e.g. a club, a social networking group, etc.) may access and/or utilize catalogs and/or contents available on devices belonging to that certain group of users. In one example, a user may choose to only share/sell most recently released songs by a certain artist available in the device catalog.

In step 409, the S/R module 105 on the first device and/or on the at least one other device causes one or more updates on availability of the one or more contents, the one or more information items or a combination thereof based, at least in part, on at least one new device joining or the at least one other device leaving a group of devices in communication with the first device. For example, a group of devices are in close proximity to each other (e.g., in a room) and have established communication channels within the group among the devices and have exchanged information associated with each device such as user profiles, device profiles, content catalogs, content items, recommendation lists and the like. In one use case scenario, a new device (e.g., a new user) joins the group, which causes the devices (e.g., at least one) already in the group to update current information on each device to reflect any changes due to new information (e.g., user profiles, device profiles, content catalogs, content items, recommendation lists and the like) associated with the new device. In another use case scenario, one of the devices already participating in the group leaves the group (e.g., leaves the room, breaks communication, etc.) and this causes the other devices in the group to update current information on each device to reflect any changes due to loss of information associated with the device leaving the group.

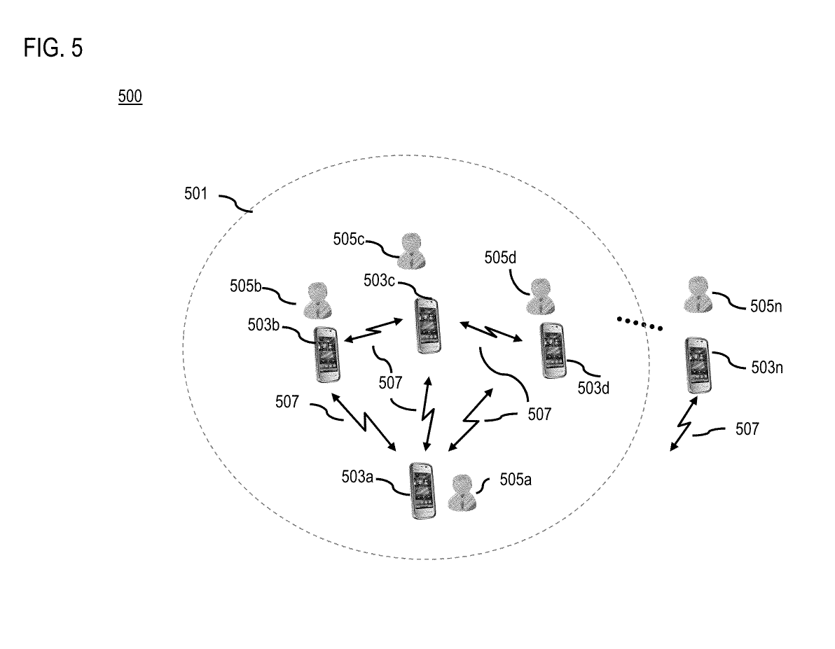

FIG. 5 is a diagram 500 of an example system including multiple users utilized in the processes of FIGS. 3 and 4, according to various embodiments. In one embodiment, FIG. 5 depicts multiple devices 503a-503n (e.g., a mobile phone) and users 505a-505n wherein the multiple devices have at least one communication link 507 (e.g., Bluetooth®, NFC, WLAN, etc.) available per each device. Further, devices 503a-503d are in close proximity area 501 and have at least one wireless communication link between each device (e.g., 505ab, 505ac, 505ad, 505bc, 505bd, 505cd, and the like). In one example, the device 503a monitors at least one proximity wireless communication channel 507 (e.g., Bluetooth®, NFC, etc.) to search for other devices and establishes at least one communication link with devices 503b-503d. Furthermore, the devices have at least one user interface (e.g., a GUI) for interacting and executing the S/R module 105 and/or applications 103 in search of content available on other devices while in an offline. Moreover, in the depicted FIG. 5, device 503n and user 505n are outside of the area 501 wherein device 503n has not established a communication link 507 with the devices in the close proximity area 501. However, if device 503n becomes substantially close to the area 501 (e.g., inside area 501, close enough to establish communication link 507, etc.), then one or more communication links 507 may be established with the devices 503a-503d in the area 501. Additionally, the at least one established communication link 507 between any two devices in the area 501 may be disconnected if a device (e.g., 503c) is removed (e.g., moved away from area 501), turned off and/or breaks communication link for any other reason. In one embodiment, if the device 503n joins the group in area 501, then one or more catalogs and/or one or more content items available on the device 503n can be shared with and presented on the 503a-503d devices and conversely, one or more catalogs and/or one or more content items available on the device 503a-503d can be shared with and presented on the 503n device. In another embodiment, if a device, for example, 503c, leaves/moves-away from the area 501 and/or breaks communication link with the other devices in the area 501, then one or more lists of catalogs and/or content items already shared with and presented on the other devices in the area 501, will be updated to indicate that one or more catalogs and/or one or more content items from the device 503c is no longer part of the list shared with and/or presented on the other devices in the area 501. In one embodiment, the devices 503a (e.g., a first device) and 503b (e.g., other device) establish at least one wireless connection between the two devices (e.g., 503ab) via the wireless communication link 507. Furthermore, the device 503a requests one or more catalogs of one or more content items available on the device 503b. Next, user 505a of the device 503a may select one or more catalogs to review one or more associated contents.

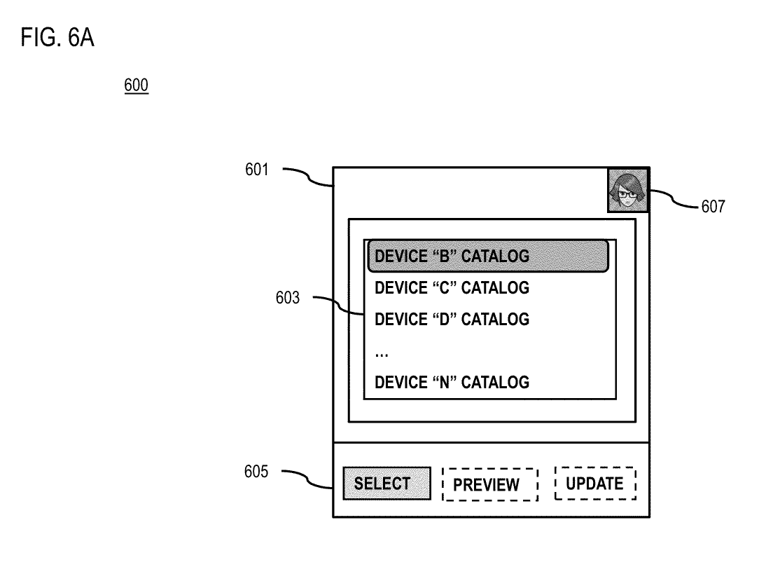

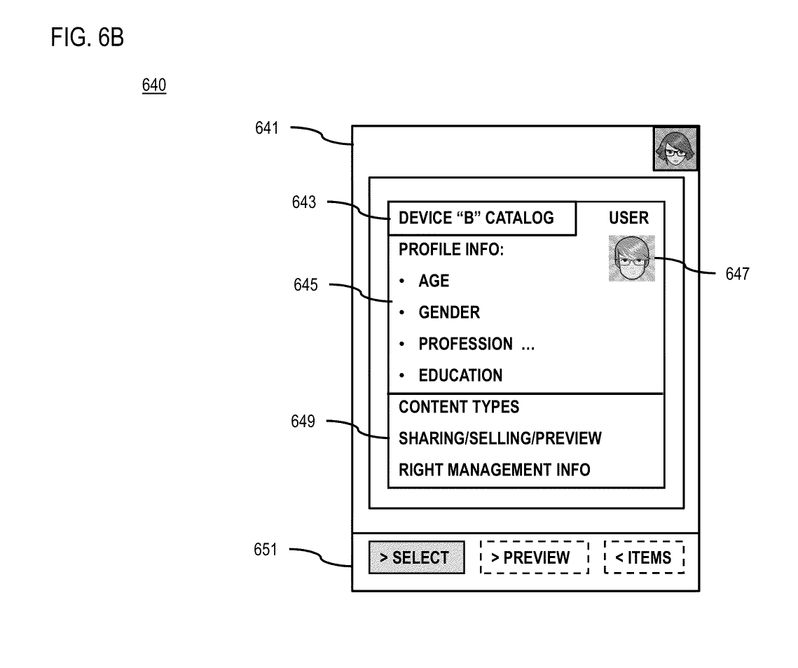

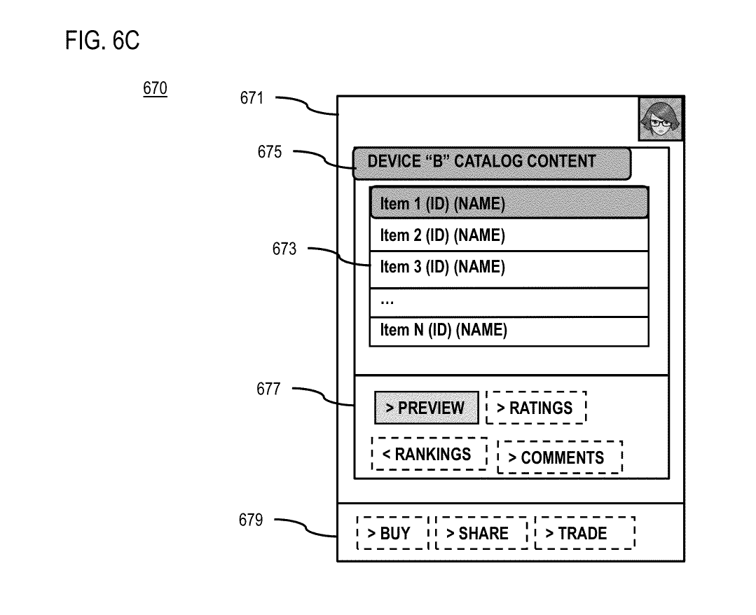

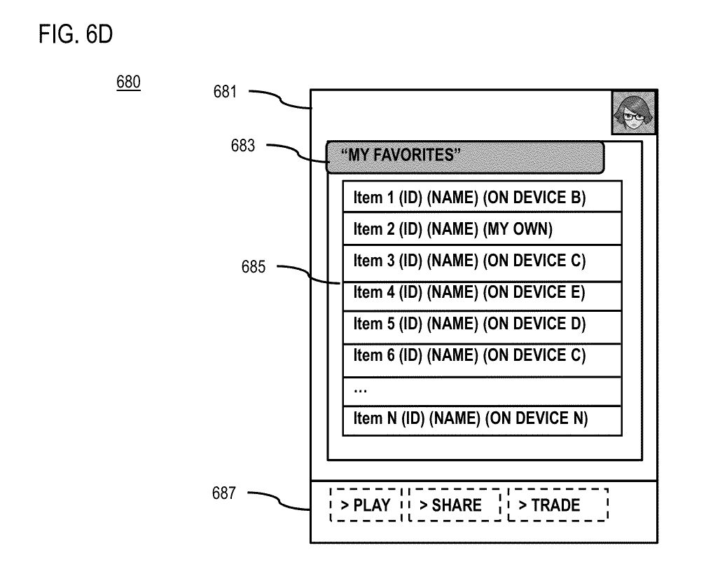

FIG. 6A is diagram 600 of an example UI for presenting one or more catalogs and/or content items on a device, according to one embodiment. In one embodiment, one or more catalogs 603 (e.g., a catalog list) are presented on a device 601 (e.g., a first device) wherein the catalogs may be from one or more other devices and may include one or more catalogs available on the device 601 (e.g., its own catalogs). Further, a user 607 of the device 601 may review the catalog list, and choose one or more actions 605 to select (e.g., device B catalog), preview, update and the like.

FIG. 6B is diagram 640 of an example UI for presenting information associated with a selected catalog, according to one embodiment. In one embodiment, one or more information items 645 and 647 associated with a catalog 643 are presented at a device 641 wherein the catalog may be available from one or more other devices or may be a catalog already available on the device 641. Further, the information items 645 may include one or more profile information items; for example, age, gender, profession, education, hobbies, and the like; associated with the user 647 of the device 643 (e.g., device “B”.) Furthermore, one or more information items 649 associated with content of the catalog 643; for example, content types, availability (e.g., for sharing, selling, preview, etc.), rights management information, the like; may be presented, whereby the user of device 641 may choose to select one or more actions 651 to “select”, “preview”, “items,” get more information, and the like.

FIG. 6C is diagram 670 of an example UI for presenting information associated with a selected catalog and one or more content items, according to one embodiment. In one embodiment, a user of device 671 (e.g., a first device) has selected to review content items 673 available from a catalog 675 available from a device “B.” Further, the catalog 675 may contain one or more content items 1-N wherein each content item may have a unique ID and name associated with the item. Furthermore, the user of device 671 may select one or more actions 677 to preview (e.g., play a music video clip), receive/review information related to one or more rating, rankings, comments, and the like. For example, the ratings, rankings, and/or comments may be those by the user of device “B” and/or by other users compiled and available at device “B.” Further, the user of device 671 may select one or more actions 679 to buy, share, trade, and the like wherein options for actions 679 may be presented by the device “B” and/or by the device 671. In one example, the user of device 671 may compare the content 673 to contents available on one or more other devices and/or content available on the device 671.

FIG. 6D is diagram 680 of an example UI for presenting information associated with a one or more content items, according to one embodiment. In one embodiment, a user of device 681 (e.g., a first device) may compile one or more content items available from one or more other devices and/or from device 681 into a list 683 to create a list 685 of favorite/top-10 content items wherein the content items 685 may have one or more associated information items to indicate, name, ID, originating device (e.g., available at which device), and the like. Further, the user of device 681 may select an action 687 to play (e.g., a song, video, etc.), share, trade, the like, the entire list 685 or a portion thereof.

The processes described herein for utilizing context and profile information in content searching and recommendation while in an offline mode may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

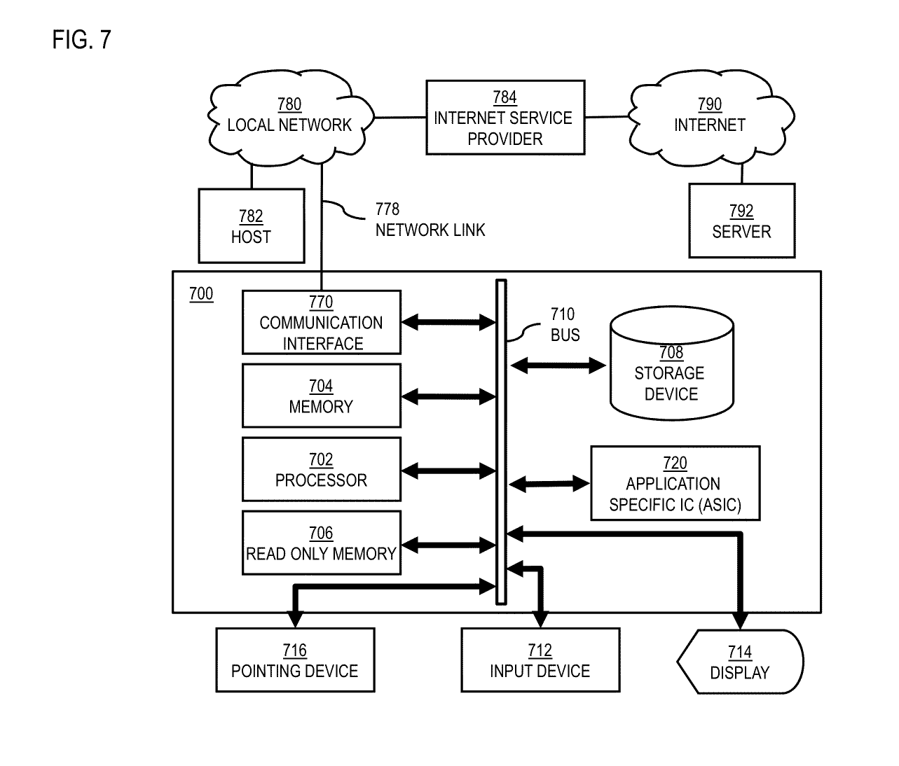

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to utilize context and profile information in content searching and recommendation while in an offline mode as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of utilizing context and profile information in content searching and recommendation while in an offline mode.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to utilizing context and profile information in content searching and recommendation while in an offline mode. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for utilizing context and profile information in content searching and recommendation while in an offline mode. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk, or flash card, for storing information, including instructions, that persists even when the computer system 700 is turned off or otherwise loses power.

Information, including instructions for utilizing context and profile information in content searching and recommendation while in an offline mode, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714, and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners, and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 109 for utilizing context and profile information in content searching and recommendation while in an offline mode to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to utilize context and profile information in content searching and recommendation while in an offline mode as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of utilizing context and profile information in content searching and recommendation while in an offline mode.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed, perform the inventive steps described herein for utilizing context and profile information in content searching and recommendation while in an offline mode. The memory 805 also stores the data associated with or generated by the execution of the inventive steps.

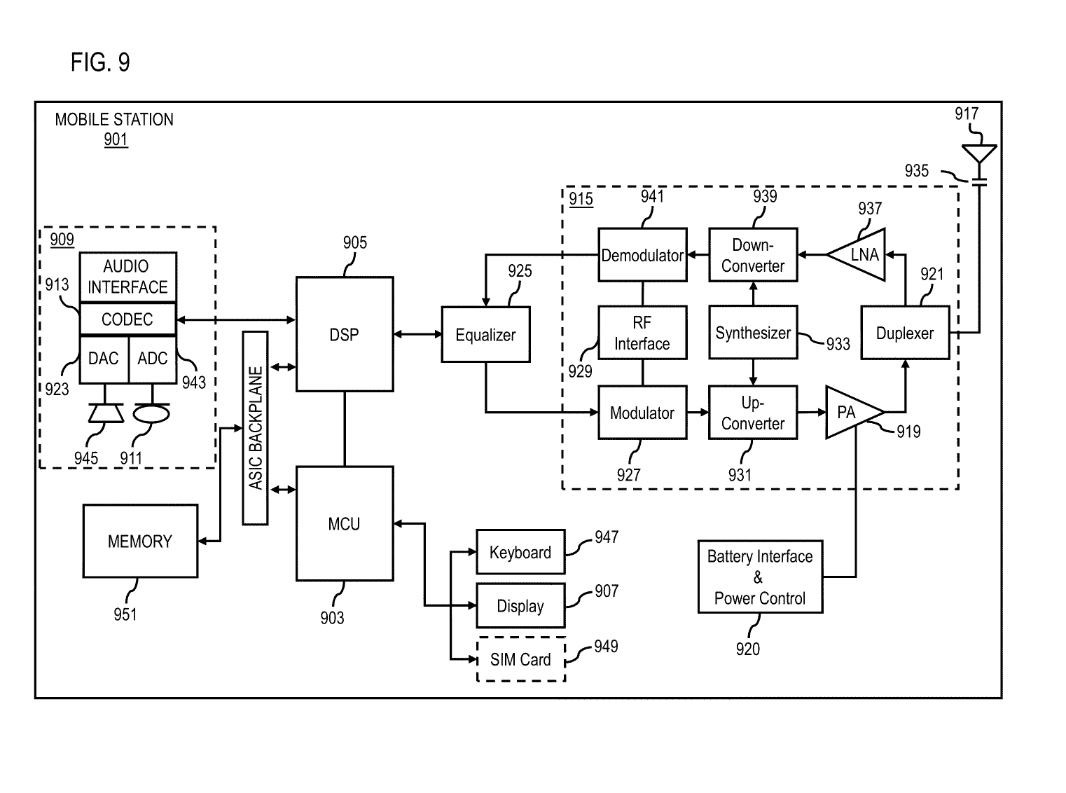

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of utilizing context and profile information in content searching and recommendation while in an offline mode. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of utilizing context and profile information in content searching and recommendation while in an offline mode. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to utilize context and profile information in content searching and recommendation while in an offline mode. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
determining, by a first device, one or more content items, one or more information items, or a combination thereof available on at least one other device;
determining one or more profiles associated with the at least one other device;
causing, at least in part, a comparison of the one or more profiles associated with the at least one other device with one or more profiles associated with the first device; and
causing, at least in part, at least one request for one or more content items, one or more information items, or a combination thereof available on the at least one other device based, at least in part, on the comparison.

2. A method of claim 1, further comprising:
causing, at least in part, a comparison of the one or more content items, the one or more information items, or a combination thereof available on the at least one other device to one or more content items, one or more information items, or a combination thereof available on the first device.

3. A method of claim 1, further comprising:
processing and/or facilitating a processing of social networking information, one or more social graphs, or a combination thereof associated with the one or more user profiles of the first device and/or of the at least one other device.

4. A method of claim 1, further comprising:
causing, at least in part, an aggregation of the one or more content items, the one or more information items or a combination thereof available on the first device and on the at least one other device.

5. A method of claim 1, wherein the one or more content items comprise one or more media items, one or more applications or a combination thereof and wherein the one or more information items comprise one or more commenting information, one or more search results, one or more content consumption histories, one or more recommendations, or a combination thereof.

6. A method of claim 1, further comprising:
determining one or more privacy policies, one or more security policies, or a combination thereof associated with the one or more content items, the one or more information items, the first device, a user of the first device, the at least one other device, a user of the at least one other device, or a combination thereof; and
causing, at least in part, a presentation of the one or more content items, the one or more information items, or a combination thereof at the first device based, at least in part, on the one or more privacy policies, the one or more security policies, or a combination thereof.

7. A method of claim 1, wherein the one or more information items include, a recommendation, a ranking, a rating, one or more comments, or a combination thereof.

8. A method of any of claim 1, wherein the first device is capable of simultaneously receiving and transmitting the one or more content items, the one or more information items, or a combination thereof, from and to the at least one other device.

9. A method of claim 1, wherein the first device and the at least one other device communicate via one or more proximity communication methods.

10. A method of claim 1, further comprising:
causing, at least in part, one or more updates on availability of the one or more contents, the one or more available information items or a combination thereof based, at least in part, on at least one new device joining or the at least one other device leaving a group of devices in communication with the first device.

11. An apparatus comprising:
at least one processor; and
at least one memory including computer program code for one or more programs,
the at least one memory and the computer program code configured to, with the at least one processor, cause the apparatus to perform at least the following,
determine, by a first device, one or more content items, one or more information items, or a combination thereof available on at least one other device;
determine one or more profiles associated with the at least one other device;
cause, at least in part, a comparison of the one or more profiles associated with the at least one other device with one or more profiles associated with the first device; and
cause, at least in part, at least one request for one or more content items, one or more information items, or a combination thereof available on the at least one other device based, at least in part, on the comparison.

12. An apparatus of claim 11, wherein the apparatus is further caused to:
cause, at least in part, a comparison of the one or more content items, the one or more information items, or a combination thereof available on the at least one other device to one or more content items, one or more information items, or a combination thereof available on the first device.

13. An apparatus of claim 11, wherein the apparatus is further caused to:
process and/or facilitate a processing of social networking information, one or more social graphs, or a combination thereof associated with the one or more user profiles of the first device and/or of the at least one other device.

14. An apparatus of claim 11, wherein the apparatus is further caused to:
cause, at least in part, an aggregation of the one or more content items, the one or more information items or a combination thereof available on the first device and on the at least one other device.

15. An apparatus of claim 11, wherein the one or more content items comprise one or more media items, one or more applications or a combination thereof and wherein the one or more information items comprise one or more commenting information, one or more search results, one or more content consumption histories, one or more recommendations, or a combination thereof.

16. An apparatus of claim 11, wherein the apparatus is further caused to:
determine one or more privacy policies, one or more security policies, or a combination thereof associated with the one or more content items, the one or more information items, the first device, a user of the first device, the at least one other device, a user of the at least one other device, or a combination thereof; and
cause, at least in part, a presentation of the one or more content items, the one or more information items, or a combination thereof at the first device based, at least in part, on the one or more privacy policies, the one or more security policies, or a combination thereof.

17. An apparatus of claim 11, wherein the one or more information items include, a recommendation, a ranking, a rating, one or more comments, or a combination thereof.

18. An apparatus of claim 11, wherein the first device is capable of simultaneously receiving and transmitting the one or more content items, the one or more information items, or a combination thereof, from and to the at least one other device.

19. An apparatus of claim 11, wherein the first device and the at least one other device communicate via one or more proximity communication methods.

20. An apparatus of claim 11, wherein the apparatus is further caused to:
cause, at least in part, one or more updates on availability of the one or more contents, the one or more available information items or a combination thereof based, at least in part, on at least one new device joining or the at least one other device leaving a group of devices in communication with the first device.
